(19) United States
(12) Patent Application Publication
(10) Pub. No.: US 2007/0241686 A1
(43) Pub. Date: Oct. 18, 2007

(54) Lamp, Assembly, Discharge Lamp and Method for Constructing Such a Lamp Assembly

(75) Inventors: Luc Lammerant, Turnhout (BE); Antonius Hermanus Alfonsus Scharenborg, Turnhout (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,703

(22) PCT Filed: May 25, 2005
(86) PCT No.: PCT/IB05/51720

§ 371 Date: Nov. 28, 2006

(30) Foreign Application Priority Data
Jun. 1, 2004 (EP) 04102443.1

(51) Int. Cl. H01J 61/36; H01J 9/00

(52) U.S. Cl. 313/624; 445/23

(57) ABSTRACT

The invention relates to a lamp assembly, comprising: a discharge lamp provided with at least one electrically conductive lamp cap, and a discharge lamp holder provided with at least one electrically conductive biasing means for exerting a pressure upon said lamp cap for holding said discharge lamp in position. The invention also relates to a discharge lamp for use in such a lamp assembly. The invention further relates to a method for constructing such a lamp assembly.

The invention relates to a lamp assembly, comprising: a discharge lamp provided with at least one electrically conductive lamp cap, and a discharge lamp holder provided with at least one electrically conductive biasing means for exerting a pressure upon said lamp cap for holding said discharge lamp in position. The invention also relates to a discharge lamp for use in such a lamp assembly. The invention further relates to a method for constructing such a lamp assembly.

In the prior art it is known to clamp a discharge lamp, in particular a High Intensity Discharge (HID) lamp in a lamp holder by means of a metal leaf spring. The leaf spring thereby exerts a pressure to a metal lamp cap making part of said discharge lamp for holding the discharge lamp in position. Moreover, said leaf spring also has an electrical function, whereas via this metal leaf spring power can be supplied to said discharge lamp. Commonly these discharge lamps are double ended and are therefore provided with two lamp caps, wherein each lamp cap is held by a separate leaf spring. The lamp assembly formed this way can be used for different applications. The aforementioned known lamp assembly is often used in the entertainment business as atmospheric lighting, such as disco and theatre lighting. However, the known lamp assembly has several drawbacks. A major drawback of the known lamp assembly is that the dimensioning of both the lamp holder and the discharge lamp is relatively critical to secure a satisfactory and reliably electrical contact between these two components. In case, however, the dimensioning of these components is not optimal, the (electrical) contact between the leaf spring and the lamp cap of the discharge lamp will be minimised, resulting in a electrical point (or thin line) contact between these components. The point contact commonly leads to local arcing between the lamp and lamp holder, resulting in a significant local increase of temperature. Due to this significant temperature increase commonly oxidation will occur of both the lamp cap and the leaf spring, leading to an accelerated lamp (assembly) failure and thus relatively short life of the lamp assembly. Due to this oxidation both the lamp cap and the lamp holder can be damaged. Moreover, since specific parts of the discharge lamp, such as a discharge vessel and two pinches, are commonly at least partially constructed out of (quartz) glass, commonly a high risk is present that the glass pinches neighbouring said lamp cap will break relatively quickly, also resulting in failure of the lamp assembly.

It is an object of the invention, to provide an improved lamp assembly, with which an adequate electrical contact between a lamp cap and a biasing means can be secured.

This object of the invention can be achieved by a lamp assembly according to the invention, characterized in that said lamp cap is adapted for multilateral engagement on said biasing means for securing adequate electrical contact between said lamp cap and said biasing means. By modifying the known lamp cap such that the lamp cap is adapted to engage said biasing means on multiple sides a permanent, relatively intensive and adequate electrical contact between said lamp cap and said biasing means can be realised, since forming of a point contact—also by application of a lamp holder or a discharge lamp with deviated dimensions—can be prevented and will thus no longer occur. A reliable and stable electrical contact between said lamp holder and said discharge lamp can thus be realised. Since a point contact will be eliminated by the special lamp cap, no arcing between said lamp cap and said biasing means will occur, thereby precluding the substantial heat development in or near these components. In this manner oxidation processes on the surfaces of these lamp components can be prevented, or at least be decelerated in a satisfactory way. Moreover, due to this reduced heat development glass components of the discharge lamp will get a significantly improved life expectancy. Therefore failure of said discharge lamp or said lamp holder will occur less easily. Noted is that said biasing means exert a pressure on said lamp cap to hold said discharge lamp in position, which means that a prestress is imposed on said lamp cap by said biasing means in order to fixate the mutual orientation between said discharge lamp and said lamp holder. It is not necessary that multiple sides of the biasing means apply a force to said lamp cap at the same time. Commonly, the way and side of engagement is dependent on the mutual relative dimensioning of said discharge lamp and said lamp holder. However, with the modified lamp cap always a reliable and stable engagement on said biasing means on said lamp cap, and therefore a adequate and satisfying mutual electrical contact can be accomplished.

In a preferred embodiment said electrically conductive biasing means is formed by a leaf spring at least partially. The leaf spring can be provided by an aperture, in particular a slot, for a (protruding) part of said lamp cap. However, it is also conceivable that multiple cooperating biasing means, in particular leaf springs, are provided for clamping said lamp cap.

Preferably, said lamp cap is adapted for engagement on said biasing means on opposite sides. In a more preferred embodiment said lamp cap comprises a base part connected to a pinch of said discharge lamp and adapted to engage one side of said biasing means, and a counter part connected to said base part and adapted to engage an opposite side of said biasing means. Commonly said counter part is positioned at a distance of said base part. Therefore said base part is preferably provided with a protruding pen to which said counter part is attached. Said biasing means is enclosed by said base part on the one side and said counter part on the opposite side, such that both said base part and said counter part are adapted to stably engage said biasing means to accomplish a reliable and adequate electrical contact between said lamp cap and said lamp holder. Under ideal conditions, wherein both the lamp holder and the discharge lamp have optimal dimensions, the biasing means commonly solely engages the base part, whereas under non-ideal conditions, wherein e.g. said discharge lamp has deviant dimensions, said biasing means often (solely) engages said counter part. However, it is imaginable to clamp (a part of) said biasing means between said base part and said counter part, in which situation both parts permanently engage said biasing means under a certain bias. In a preferred embodiment said base part and said counter part are mutually connected by means of a pen extending through an aperture formed in said biasing means a mentioned afore. Said counter part can be fixed rigidly to said pen, by which the lamp cap can be formed integrally by a single piece. However, in another preferred embodiment said counter part is releasably connected with said base part. Said counter part can thereby be attached to said pen in different ways, e.g. by way of a bayonet catch or by way of an Allen screw (socket cap). Preferably, said pen is provided with an outer screw thread, whereas said counter part is provided with a cooperating inner screw thread. Therefore, the mutual distance between said base part and said counter part is preferably adjustable, in order to facilitate de(installation) of the lamp assembly according to the invention. Moreover, the mutual distance can be optimised to secure a permanent and adequate technical contact between said lamp cap and said lamp holder. However, preferably the minimal mutual distance between said base part and said counter part is predetermined in order to facilitate construction of the lamp assembly according to the invention for inexperienced persons.

In another preferred embodiment said discharge lamp is provided with two lamp caps, wherein each cap is held in position by at least one biasing means. Double ended discharge lamps are commonly linearly formed lamps wherein a lamp cap is provided at both extremes. Each lamp cap is thereby connected to a single electrode of said discharge lamp.

Thus, by simply engaging each lamp cap by a separate (set of) biasing means the lamp assembly can be constructed. Each lamp is thereby adapted to engage said biasing means at least bilaterally.

In a preferred embodiment said discharge lamp is formed by a High Intensity Discharge (HID) lamp. A HID lamp is a relatively efficient lamp, since this type of lamp is able to produce light with a relatively high intensity, while its volume can be retained relatively small.

The invention also relates to a discharge lamp for use in a such lamp assembly, wherein said discharge lamp is provided with at least lamp cap adapted for multilateral engagement on at least one biasing means making part of a lamp holder for securing adequate electrical contact between said lamp cap and said biasing means.

The invention further relates to a method for constructing such a lamp assembly, comprising the steps of: a) placing said discharge lamp in said lamp holder, such that pressure is exerted by a biasing means on a base part of a lamp cap of said discharge lamp for holding the discharge lamp in position, and b) coupling a counter part to said base part to secure adequate electrical contact between said biasing means and said lamp cap.

Advantages of this method according to the invention are already elucidated above in a comprehensive manner.

The invention can be illustrated by way of the following, non-limitative embodiments, wherein:

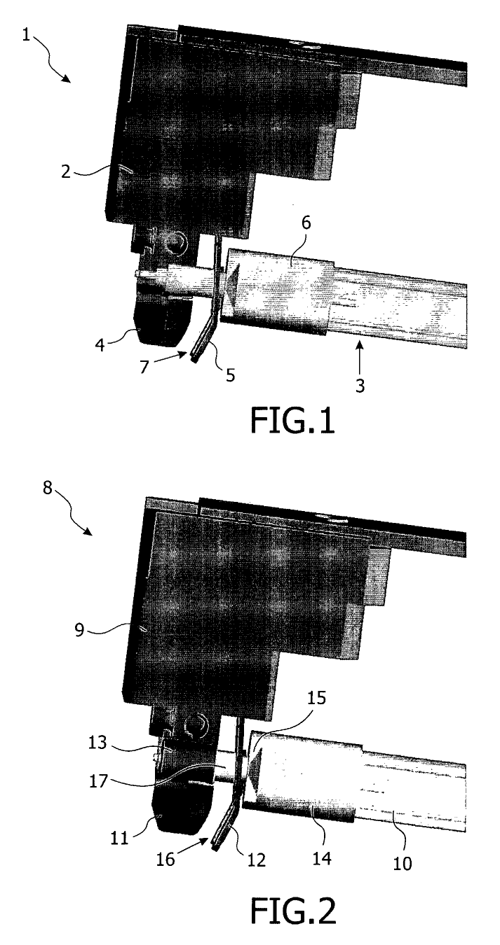

FIG. 1 shows a perspective view of a part of a known lamp assembly,

FIG. 2 shows a perspective detailed view of a part of a lamp assembly according to the invention, and

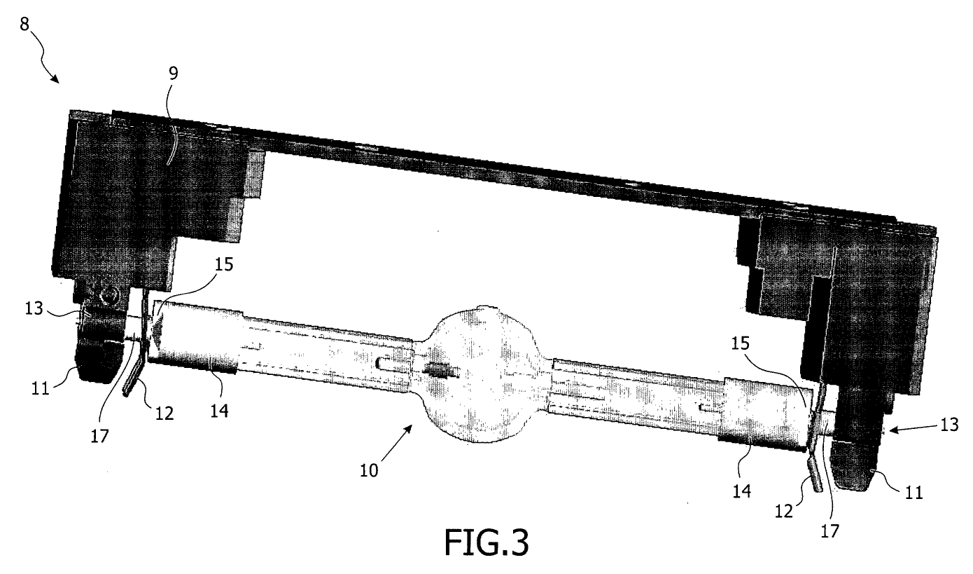

FIG. 3 shows a perspective view of a the whole lamp assembly as shown in FIG. 2.

FIG. 1 shows a perspective view of a part of a lamp assembly 1 according to the invention. The lamp assembly 1 comprises a lamp holder 2 and a discharge lamp 3 connected to said lamp holder 2 by means of two types of leaf springs 4, 5. A first type of leaf springs 4 consists at two mutually cooperating leaf springs 4 (only one is shown) between which a lamp cap 6 of said discharge lamp 3 is clamped mechanically. A second leaf spring 5 is provided with a slot 7 in through which the lamp cap 6 extends. The second leaf spring 5 has a bilateral functionality, whereas this second leaf spring 7 is adapted both to mechanically secure said lamp cap 6 and to make electrical contact between said lamp holder 2 and said discharge lamp 3 in order to be able to supply power to said discharge lamp 3. However, in practice it has been found that an (optimal) electrical contact will merely occur in case both the lamp holder 2 and the lamp 3 have ideal mutual dimensions. If, for example, the discharge lamp 3 has a relatively short length, then a optimal and permanent electrical contact cannot be secured, resulting in an accelerated failure of one of more components of said lamp 3 as elucidated above.

FIG. 2 shows a perspective detailed view of a part of a lamp assembly 8 according to the invention. The lamp assembly 8 as a whole is shown in FIG. 3. The assembly comprises a lamp holder 9 and a discharge lamp 10 releasably connected to said lamp holder 9. To accomplish this mutual connection said lamp holder 9 is provided with two types of leaf springs 11, 12. A first set of two leaf springs 11 (only one is shown in FIG. 2) is adapted to clamp an electrically conductive outer bush 13 of a lamp cap 14 of said discharge lamp 10 one-sidedly. A second single leaf spring 12 is adapted to impose a prestress on a base part 15 of said lamp cap 14. Therefore the second leaf spring 12 is provided with a slot 16 through which a pen 17 of said lamp cap 14 extends. By way of this slot 16 the discharge lamp 10, in particular said pen 17, can be placed relatively easily in position. It is noted that the slot 16 can be replaced by a bore through which the pen 17 can be extended, since the second leaf springs 12 are adapted to spring in a direction away from or towards to said discharge lamp 10, and which still facilitates installation of the lamp assembly 8. By means of the leaf springs 11, 12 the mutual orientation between said lamp holder 9 and said discharge lamp 10 can be fixed in any direction. In this embodiment electrical power can be supplied to the lamp cap 14 via both the first leaf springs 11 and the second leaf spring 12. In this manner a stable, reliable and adequate power transfer can be achieved. It is conceivable to achieve this stable and adequate electrical contact in another way then by means of a conductive outer bush 13. For example, it is imaginable to thicken the outer end of said lamp cap 14 in another way, for instance by applying a conductive nut around the outer end of said lamp cap 14 or by applying another conductive counter cap around the outer end of said lamp cap 14 to secure a permanent and satisfying electrical contact between said lamp holder 9 and said discharge lamp 10. Therefore the local temperature at or near the cap 14 will not rise significantly resulting in a relatively long life span of both the lamp holder 9 and the lamp 10.

It will be apparent that the invention is not limited to the exemplary embodiments shown and described here, but that numerous variants, which will be obvious to the skilled person in the field, are possible within the scope of the appended claims.

1. Lamp assembly, comprising:
a discharge lamp provided with at least one electrically conductive lamp cap, and
a discharge lamp holder provided with at least one electrically conductive biasing means for exerting a pressure upon said lamp cap for holding said discharge lamp in position, characterized in that said lamp cap is adapted for multilateral engagement on said biasing means for securing adequate electrical contact between said lamp cap and said biasing means.

2. Assembly according to claim 1, characterized in that said electrically conductive biasing means is formed by a leaf spring at least partially.

3. Assembly according to claim 1, characterized in that said lamp cap is adapted for engagement on said biasing means on opposite sides.

4. Assembly according to claim 3, characterized in that said lamp cap comprises a base part connected to a pinch of said discharge lamp and adapted to engage one side of said biasing means, and a counter part connected to said base part and adapted to engage an opposite side of said biasing means.

5. Assembly according to claim 4, characterized in that said base part and said counter part are mutually connected by means of a pen extending through an aperture formed in said biasing means.

6. Assembly according to claim 4, characterized in that said counter part is releasably connected with said base part.

7. Assembly according to claim 4, characterized in that the mutual distance between said base part and said counter part is adjustable.

8. Assembly according to claim 7, characterized in that the minimal mutual distance between said base part and said counter part is predetermined.

9. Assembly according to claim 1, characterized in that said lamp cap is coupled to said lamp holder by means of multiple biasing means each engaging said lamp cap.

10. Assembly according to claim 1, characterized in that said discharge lamp is provided with two lamp caps, wherein each cap is held in position by at least one biasing means.

11. Assembly according to claim 1, characterized in that said discharge lamp is formed by a High Intensity Discharge (HID) lamp.

12. Discharge lamp for use in a lamp assembly according to claim 1.

13. Method for constructing a lamp assembly according to claim 4, comprising the steps of:
placing said discharge lamp in said lamp holder, such that pressure is exerted by a biasing means on a base part of a lamp cap of said discharge lamp for holding the discharge lamp in position, and
coupling a counter part to said base part to secure adequate electrical contact between said biasing means and said lamp cap.
